(19) United States
(12) Patent Application Publication
(10) Pub. No.: US 2005/0060172 A1
(43) Pub. Date: Mar. 17, 2005

(54) Information delivery system and information delivery method

(75) Inventors: Minoru Soda, Aichi (JP); Shinji Koyama, Aichi (JP); Motoki Ootsuka, Aichi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Token Corporation

(21) Appl. No.: 10/874,836

(22) Filed: Jun. 23, 2004

(30) Foreign Application Priority Data
Jun. 26, 2003 (JP) 2003-182120

(51) Int. Cl. G06F 17/60

(52) U.S. Cl. 705/1; 705/7

(57) ABSTRACT

An information delivery system is disclosed which is under control of one real estate agent and delivers information about real estate handled by the one real estate agent via an Internet or the like to terminal units belonging to other real estate agents admitted by the one real estate agent respectively. The system includes a delivery information data base storing a plurality of pieces of information about real estate to be delivered to the terminal units, a terminal unit data base storing a mail address, telephone number and another communication address for the terminal units, a narrowing condition data base storing narrowing conditions set for every one of the other real estate agents, and a delivering unit narrowing the information about the real estate stored by the delivery information data base on the narrowing conditions for every one of the real estate agents for delivering, to the terminal unit stored by the terminal unit data base, the narrowed information about real estate.

### BACKGROUND OF THE INVENTION

1. Field of the Invention

This invention relates generally to an information delivery system and method for delivering information to a person wishing for the information, and more particularly to such an information delivery system and method for delivering information about real estate handled by one real estate agent to another real estate agent.

2. Description of the Related Art

Information delivery systems of the above-described type are disclosed by JP-A-2002-7541, JP-A-2002-92124 and JP-A-2003-30305. In the disclosed systems, information about real estate is delivered from server equipment to a terminal unit of each of a plurality of real estate agents who stand on an equality with the server equipment.

Information about real estate is a source from which a real estate agent gains a profit and accordingly, cannot easily be supplied to other real estate agents. There is a possibility that a real estate agent may forfeit his or her confidence in an owner of real estate when the real estate remains empty or unsold for a long period of time. Further, there is a case where a real estate agent is under contract with a real estate owner to pay a rent on the real estate remaining unsold for a long period of time. In this case, the real estate agent reluctantly supplies information about the real estate to other real estate agents in order to reduce the loss. However, real estate agents located near the real estate remaining unsold conventionally need to be checked up one by one, delivering information about the real estate to the checked real estate agents by facsimile or the like. Accordingly, the working efficiency is low.

### SUMMARY OF THE INVENTION

Therefore, an object of the present invention is generally to deliver information more efficiently, and more specifically to provide an information delivery system and an information delivery method which can deliver information about real estate between real estate agents more efficiently.

The present invention provides an information delivery system which is under control of one real estate agent and delivers information about real estate handled by said one real estate agent via an Internet, telephone line or another network to terminal units belonging to other real estate agents admitted by said one real estate agent respectively. The system comprises a delivery information data base storing a plurality of pieces of information about real estate to be delivered to the terminal units, a terminal unit data base storing a mail address, telephone number and another communication address for the terminal units, a narrowing condition data base storing narrowing conditions set for every one of said other real estate agents, and delivering means narrowing the information about the real estate stored by the delivery information data base on the narrowing conditions for every one of said other real estate agents for delivering, to the terminal unit stored by the terminal unit data base, the narrowed information about real estate.

A plurality of pieces of information about real estate are stored on the delivery information data base. The one real estate agent has not sold the real estate or has not made a lease contract with respect to the real estate. These pieces of information about the real estate can be delivered to the terminal units of the other admitted real estate agents. Consequently, the selling or making a lease contract can be enhanced with respect to things real. Moreover, since the information about real estate is narrowed for every one of the other real estate agents, an amount of information possessed by each of the other real estate agents can be prevented from being excessive, whereupon business efficiency can be improved. More specifically, consider the case where the real estate the data of which is contained in the real estate information to be delivered is located in the same area as a business office of one of said other real estate agents to whom the real estate information is to be delivered is located. When this is a narrowing condition, information about real estate located farther away from business offices of the other real estate agents can be eliminated. As a result, the other real estate agents can obtain only necessary information. Furthermore, even when one of the other real estate agents has sold the real estate or has made a lease contract with respect to the real estate, the one real estate agent can also gain a profit if the one real estate agent delivers, to the other real estate agents, the real estate the one real estate agent can manage. Additionally, consider the case where an owner of the real estate imposes a predetermined amount of payment on the one real estate agent when a real estate remains unsold for more than a predetermined period. In this case, when information about the real estate is delivered to the other real estate agents, the one real estate agent can reduce a loss.

The present invention also provides a method of information delivery wherein an information delivery system which is under control of one real estate agent delivers information about real estate handled by said one real estate agent via an Internet, telephone line or another network to terminal units belonging to other real estate agents admitted by said one real estate agent respectively. The method comprises storing an electronic-mail (E-Mail) address, telephone number and another communication address on a terminal unit data base in response to requirement by each of said other real estate agents, storing, on a narrowing condition data base, narrowing conditions set for every one of said other real estate agents in response to requirement by each of said other real estate agents or according to a location of a business office of each said other real estate agent, storing, on a delivery information data base, information about real estate in response to operation by said one real estate agent or when the real estate remains unsold for more than a predetermined period, and narrowing a plurality of pieces of real estate information stored on the delivery information data base for every one of said other real estate agents on the basis of the narrowing conditions and delivering the real estate information to the terminal unit the data of which is stored on the terminal unit data base.

A plurality of pieces of information about real estate are stored on the delivery information data base. The one real estate agent has not sold the real estate or has not made a lease contract with respect to the real estate. These pieces of information about the real estate can be delivered to the terminal units of the other admitted real estate agents. Consequently, the selling and making a lease contract can be enhanced with respect to real estate.

### BRIEF DESCRIPTION OF THE DRAWINGS

Other objects, features and advantages of the present invention will become clear upon reviewing the following description of the embodiment with reference to the accompanying drawings, in which:

FIG. 1 illustrates an outline of the information delivery system in accordance with one embodiment of the present invention;

FIG. 2 is a block diagram showing data flow in the real estate information management system;

FIG. 3 illustrates an outline of table of admitted agents;

FIG. 4 illustrates an outline of table of candidate for delivery;

FIG. 5 illustrates an outline of table of delivery allowance;

FIG. 6 illustrates an outline of table of unconditional delivery;

FIG. 7 illustrates an outline of table of delivery in which date and time are designated;

FIG. 8 illustrates an outline of table of on-demand delivery; and

FIG. 9 shows a browser screen in a case where access has been made from a terminal unit to the information delivery system.

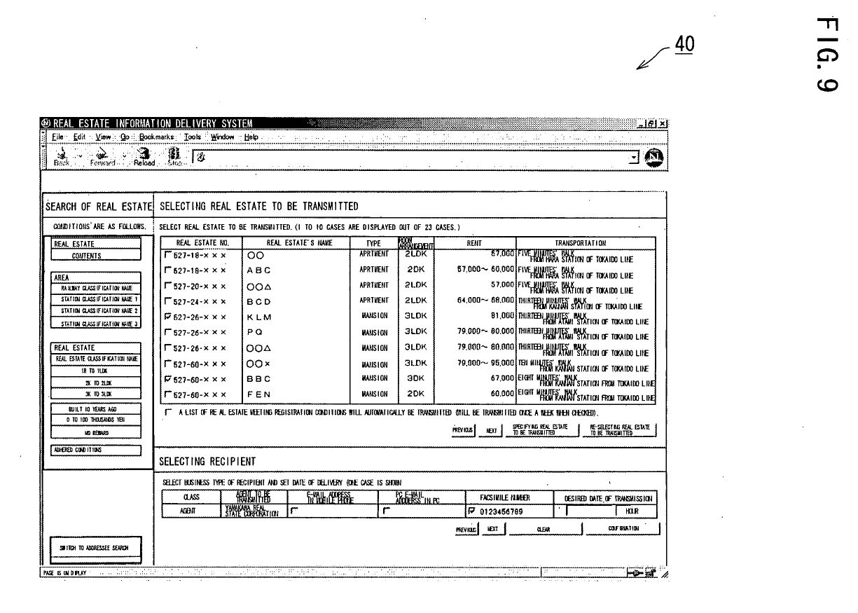

### DETAILED DESCRIPTION OF THE INVENTION

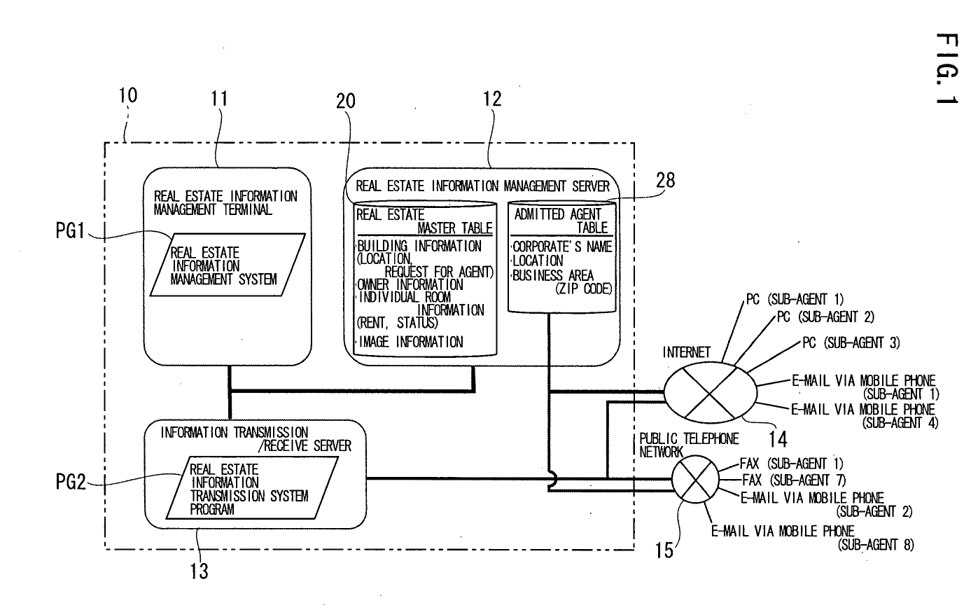

One embodiment of the present invention will be described with reference to the accompanying drawings. Referring to FIG. 1, an information delivery system 10 in accordance with one embodiment of the invention is shown as being connected to an Internet 14 and public telephone line network 15. The information delivery system 10 is under control of a real estate agent A who corresponds to one real estate agent in the present invention. The information delivery system 10 comprises a real estate information management terminal 11, a real estate information management server 12 and an information transmission/receive server 13. A real estate information management system PG1 (software) is installed in the real estate information management terminal 11. A real estate information transmission system program PG2 (software) is installed in the information transmission/receive server 13. The real estate information management server 12 is provided with a storage device storing a real estate master table 20 serving as a master data base in the invention and admitted agent table 28. The admitted agent table 28 stores information about a plurality of other real estate agents to whom agent A connected the business tie-up. The other real estate agents will hereinafter be referred to as “admitted agents.”

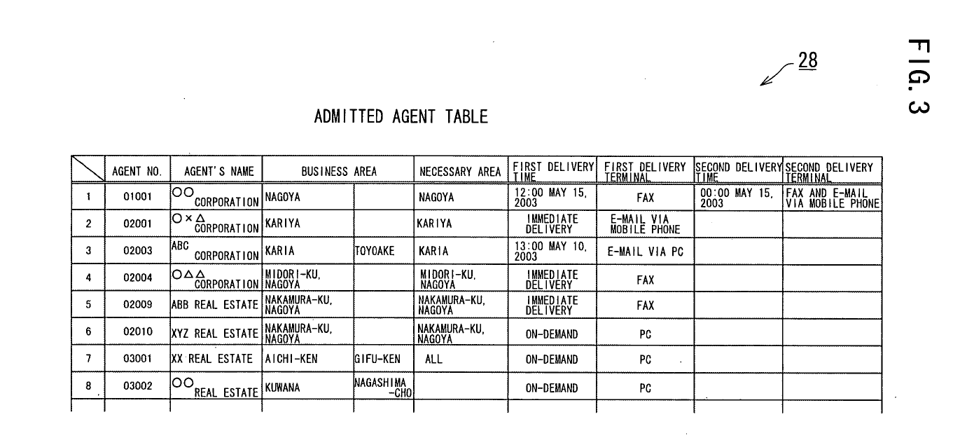

An admitted agent can get a password when having connected the business tie-up to agent A. When accessing the information delivery system 10 of agent A on the Internet 14 by a terminal unit of a personal computer, mobile phone or the like, the admitted agent is asked to input the password. When the admitted agent inputs the password, the screen is changed to a menu screen (not shown). When the admitted agent advances to a setting/change screen, items of the setting/change screen are displayed. The items of the setting/change screen include “required area,” “first delivery time/delivery terminal,” “second delivery time/delivery terminal” and the like. An admitted agents table as shown in FIG. 3 is originated on the basis of data the admitted agent has entered into the setting/change items. The “required area” designates an area to which real estate the agent A wishes to deliver belongs and is usually the same area (city or town, for example) where a business office of the admitted agent is located. When “All” is entered into the “required area,” all pieces of real estate information agent A can deliver are delivered. Furthermore, when the item, “required area” has no entry, the same city or town as an area where the admitted agent is located is automatically set.

The item of “delivery time” includes sub-items of (1) immediate delivery, (2) on-demand, and (3) date designation in which “date” includes hour as well as date. When sub-item (1) immediate delivery has been selected, real estate information is delivered to the admitted agent immediately when agent A possesses the deliverable real estate information. When sub-item (2) on-demand has been selected, the admitted agent can get real estate information when having looked into a delivery box via a terminal unit. When sub-item (3) date designation has been selected, the admitted agent can designate a delivery time. Furthermore, sub-items of “delivery time” and “delivery terminal” can be set as one set of item. For example, a plurality of sub-items of “delivery time” can be set so that sub-items of “delivery terminal” may be changed for every “delivery time.” Additionally, a plurality of sub-items of “delivery terminal” may be set at the same “delivery time.” Consequently, pieces of real estate information can be obtained by facsimile and by mobile phone at the same delivery time. Data stored as “delivery terminal” on an admitted agent table 28 serves as “terminal unit data base” in the invention, whereas data stored as “required area” serves as narrowing condition data base in the invention.

The real estate master table 20 of the real estate information management server 12 stores information about real estate handled by agent A. There are various types of contracts made between a real estate agent and a real estate owner. For example, a rent compensation contract specifies that agent A shall pay the real estate owner the rent when the real estate remains unsold for more than a predetermined period. Further, even when a lease contract has been made between the real estate owner and another real estate agent, a specified management contract is sometimes made in order that management of rent, management of maintenance or the like may be entrusted to agent A. In many cases, the aforesaid admitted real estate agent has difficulty in executing the rent management, maintenance management or the like.

The real estate information management system PG1 installed in the real estate information management terminal 11 includes a delivered information extracting process 31, a renewing process 32 and a delivery table originating process 33. Data to be delivered from the terminal 11 and the server 12 is originated by the aforesaid processes 31 to 33. The delivered information extracting process 31 originates a delivered candidate table 21 on the basis of a real estate master table 20. More specifically, information about real estate regarding which the aforesaid rent compensation contract and specified management contract have been made is retrieved from among real estate information stored by the real estate master table 20. Retrieved pieces of information are stored in the delivered candidate table 21. Furthermore, real estate agent A may select real estate information stored on the real estate master table 20 and store the selected information on the delivered candidate table 21.

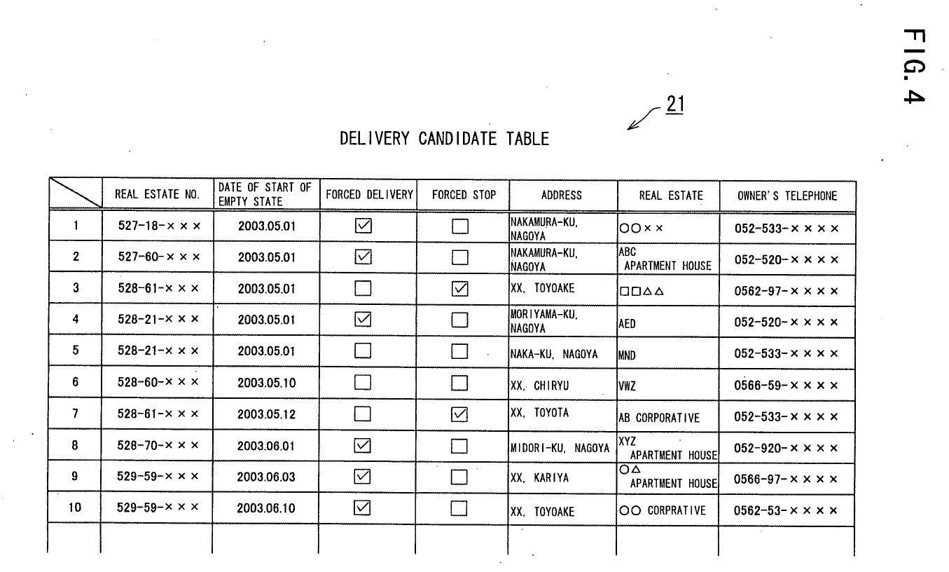

The delivered candidate table 21 stores “real estate number,” “address,” “real estate name,” “owner's telephone number” of each real estate and the like, which pieces of information are contained in the real estate information stored on the real estate master table 20, as shown in FIG. 4. Furthermore, the delivered candidate table 21 is provided with an item of “beginning date of unsold state” and check boxes of “forced delivery” and “forced stop.” The date when the real estate has become unsold is entered into the item of “start date of empty state.” A check is entered into or deleted from each check box by real estate agent A.

A delivery allowance table 22 is originated from the delivered candidate table 21 in the renewing process 32. More specifically, data of real estate with a check in the box of “forced delivery” is selected from the delivered candidate table 21 to be stored on the delivery allowance table 22. Furthermore, a predetermined allowed unsold period is set in the renewing process 32. The allowed unsold period is added to the “start date of unsold state”. Data of the real estate in which the unsold period has exceeded the period obtained by the addition is retrieved to be stored on the delivery allowance table 22. Data of the real estate with a check in the box of “forced stop” is eliminated.

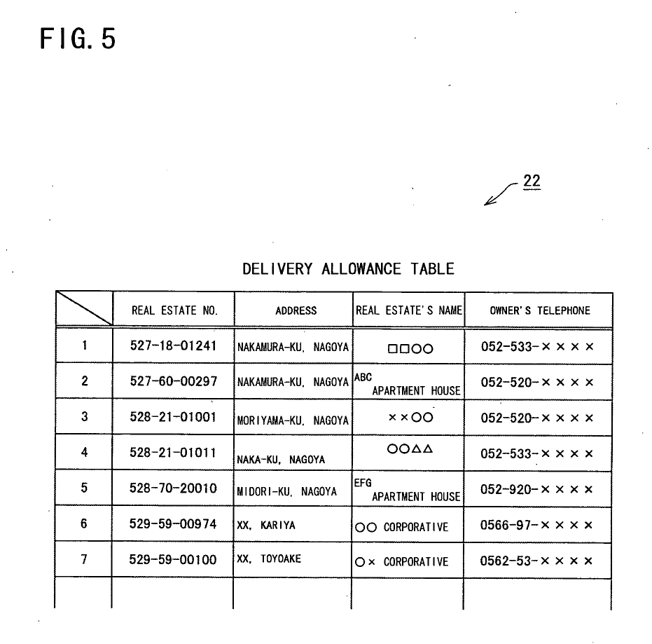

FIG. 5 shows the delivery allowance table 22. Data stored on the delivery allowance table 22 corresponds to “delivered information data base” in the invention. Thus, the delivery allowance table 22 stores data of the real estate which have been allowed to be delivered to admitted real estate agents.

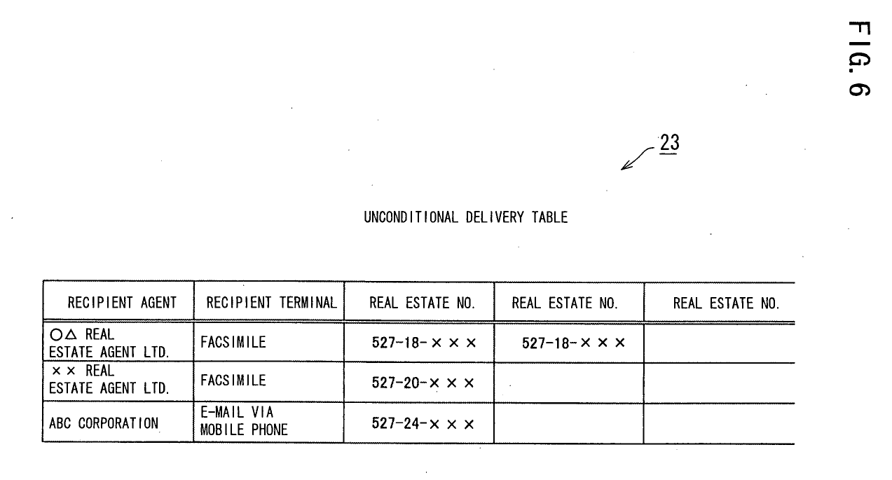

In the delivery table originating process 33 are originated an unconditional delivery table 23, a date and time designated delivery table 24 and an on-demand delivery table 25. More specifically, the unconditional delivery table 23 is shown in FIG. 6. In order that the unconditional delivery table 23 may be originated, each admitted agent for whom the delivery time is set for “immediate delivery” on the admitted agent table 28 (see FIG. 3) is retrieved. Real estate corresponding with the “required area” (see FIG. 3) desired by each admitted agent is retrieved from the delivery allowance table 22 or narrowed. The “real estate agent” to whom real estate information is to be delivered and the “terminal” to which the information is to be delivered are stored on the unconditional delivery table 23 together with the “real estate number” of the narrowed real estate, as shown in FIG. 6.

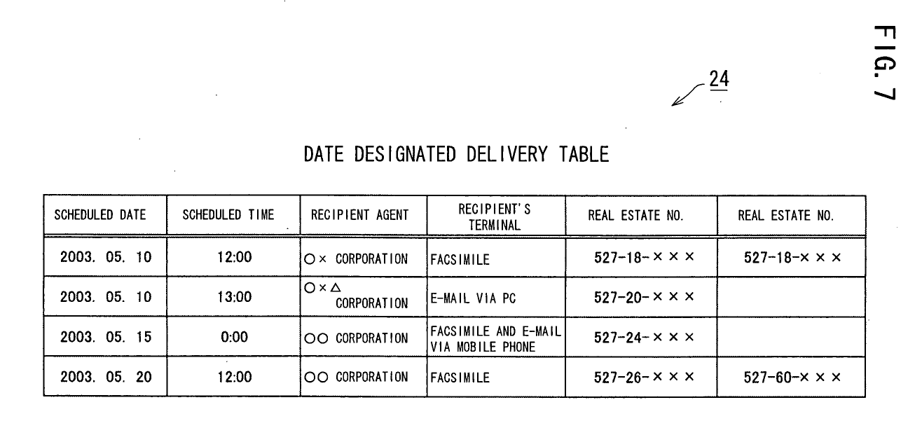

FIG. 7 shows the date designated delivery table 24. In order that the date designated delivery table 24 maybe originated, the delivery table originating process 33 retrieves each real estate agent for whom a designated time is stored as the “delivery time” on the admitted agent table 28. The process 33 further retrieves real estate corresponding with the “required area” (see FIG. 3) desired by each retrieved agent is retrieved from the delivery allowance table 22 (see FIG. 5) or narrowed. The process 33 further stores “delivery date and time” of each retrieved agent stored on the admitted agent table 28 (more specifically, “scheduled delivery date” and “scheduled delivery time”) and the “terminal to which information is to be delivered” together with the “real estate number” of the narrowed real estate.

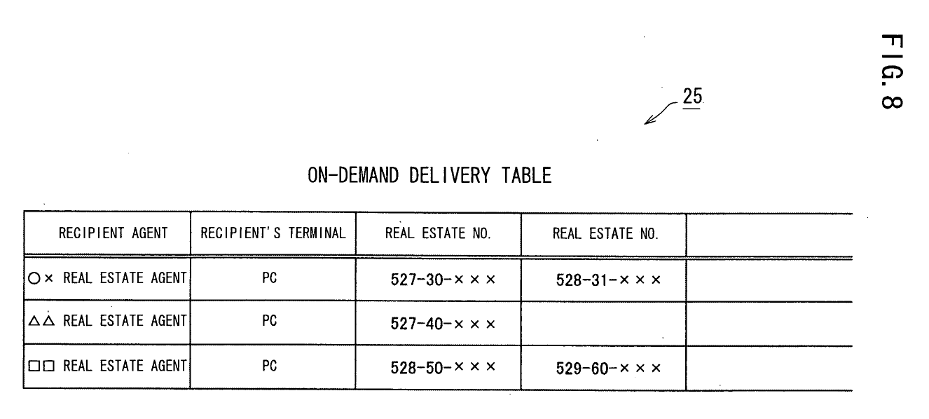

FIG. 8 shows the on-demand delivery table 25. In order that the on-demand delivery table 25 may be originated, the delivery table originating process 33 retrieves each admitted agent for whom the “on-demand” has been set (see FIG. 3) in the admitted agent table 28. The process 33 further retrieves real estate corresponding with the “required area” (see FIG. 3) desired by each admitted agent is retrieved from the delivery allowance table 22 or narrowed. The “real estate agent” to whom real estate information is to be delivered and the “terminal” to which the information is to be delivered are stored on the on-demand delivery table 25 together with the “real estate number” of the narrowed real estate, as shown in FIG. 8.

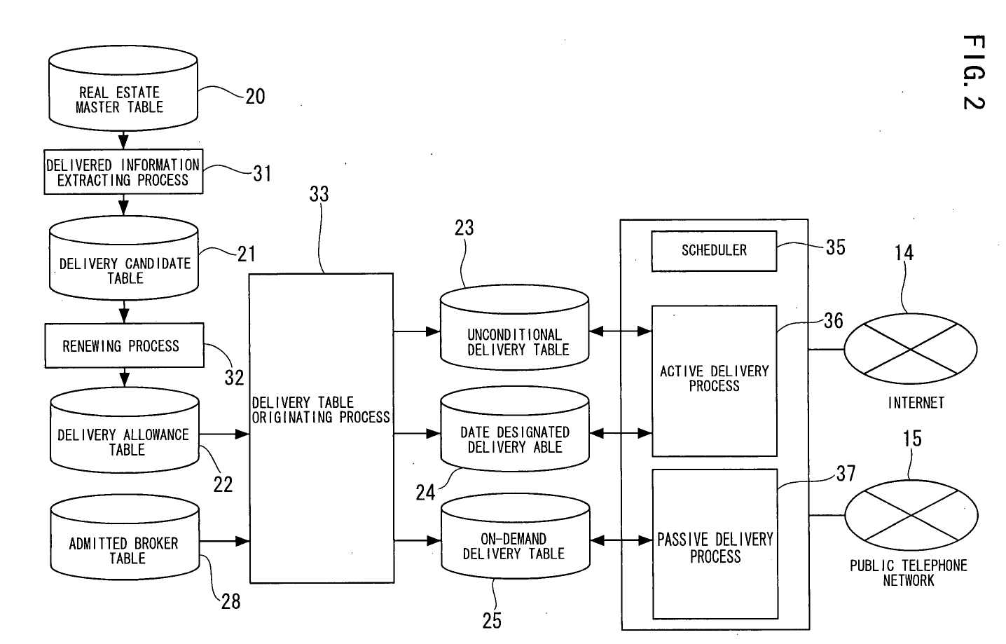

Referring now to FIG. 2, the real estate information transmission system program PG2 stored on the information transmission/receive server 13 is provided with an active delivery process 36 and a passive delivery process 37 both of which serve as delivering means in the invention. The active delivery process 36 starts up at predetermined intervals on the instructions of a scheduler 35, opening the unconditional delivery table 23 and the date and time designated delivery table 24. The active delivery process 36 further delivers real estate information to each admitted agent stored on the unconditional delivery table 23, immediately unconditionally. Regarding the date and time designated delivery table 24, on the other hand, data for which the “delivery time” has expired is selected so that real estate information is delivered to each admitted agent for whom the “delivery time” has expired. Furthermore, when the “delivery terminal” stored on the unconditional delivery table 23 and the date and time designated delivery table 24 is a facsimile machine, the active delivery process 36 delivers real estate information as facsimile data through the public telephone line network 15. Additionally, when the “delivery terminal” stored on the unconditional delivery table 23 and the date and time designated delivery table 24 is a personal computer or a mobile phone, the active delivery process 36 delivers real estate information as E-Mail through the Internet 14.

The admitted agent for whom the delivery time is set for “on-demand” accesses the real estate information delivery system 10. In this case, when the “delivery terminal” stored on the on-demand delivery table 25 is a facsimile machine, the passive delivery process 37 delivers real estate information as facsimile data through the public telephone line network. When the “delivery terminal” stored is a personal computer or mobile phone, the passive delivery process 37 delivers real estate information as E-Mail through the Internet 14.

The real estate information delivered in the embodiment is supposed to be in the form of a table. The table may be expanded so that a retrieving function column is provided so as to be checked by the admitted agent table 28. Consequently, the real estate information according to a wider range of needs can be offered. More specifically, when an admitted agent having checked the retrieving function column accesses the real estate information delivery system 10 via the Internet 14, the real estate information of the on-demand delivery table 25 is delivered on a browser screen 40. For a further narrowing of real estate information, the browser screen 40 is provided with a conditional retrieval function on a left-hand column and displays the results of retrieval on the upper right-hand column. The browser screen 40 is further provided with a check column checked so that necessary real estate information is selected from the displayed results of retrieval. Additionally, a delivery form includes an all-at-a-glance type and an each-on-one-copy type so that various needs are met. A setting column switchable to a terminal unit receiving real estate information is provided on the lower right-hand column.

Thus, each admitted agent can obtain necessary real estate information in a desired form according to his or her needs. Furthermore, in the case of delivery by E-Mail, information about URL linked with home pages containing more detailed information, floor plans, photograph of real estate appearance, etc. may be contained such that more useful E-Mail can be delivered.

In the information delivery system 10 of the embodiment, the delivery allowance table 22 stores information about the real estate regarding which a predetermined empty or unsold period has expired. The information stored on the delivery allowance table 22 can be delivered to the terminal units of the admitted agents or the other real estate agents. Consequently, sale of real estate or lease contract can be promoted. Since the information about the real estate is narrowed into that located in an area suitable for each agent and delivered, each admitted agent can be prevented from an excessive amount of information and the working efficiency can be improved. Furthermore, each admitted agent sells the real estate or make a lease contract, based on the delivered information about the real estate. Consequently, each admitted agent can increase his or her profit.

Furthermore, the real estate information delivered from agent A to each admitted agent includes that with a specific management contract that agent A can manage the real estate even after the admitted agent has sold the real estate or made a lease contract regarding the real estate. The real estate information delivered from agent A to each admitted agent further includes that with a rent guarantee contract that when the unsold state of the real estate has exceeded a predetermined period, agent A shall pay a predetermined amount to an owner of the real estate. Consequently, agent A can expect restoration of profit or a reduction in the loss.

Furthermore, when the real estate the data of which is contained in the real estate information remains unsold or empty over the predetermined period, the real estate is automatically stored on the delivery allowance table 22 thereby to be able to be delivered. This can prevent a failure to deliver the real estate information remaining unsold or empty. Moreover, since the real estate information is delivered on the delivery date designated by the admitted agent to the terminal unit, the real estate information can be delivered to the admitted agent at a most suitable time, in a most suitable place and most suitable form.

The present invention should not be limited by the foregoing embodiments and accordingly, the technical range of the present invention encompasses modifications as described below.

The information delivery system 10 of the foregoing embodiment may be linked with a system providing general purchasers and lodgers with real estate information, so that selling and lease contract regarding real estate are reflected on the data of the real estate master table 20.

The real estate information is supplied to the admitted agents in the foregoing embodiment. However, the real estate information may be supplied to general public desiring the information, instead of the admitted agents.

The foregoing embodiment exemplifies agency of real estate. However, the contents of the information should not be limited to real estate. The contents of information may be movable property such as automobiles, jewelry or the like.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. An information delivery system which is under control of one real estate agent and delivers information about real estate handled by said one real estate agent via an Internet, telephone line or another network to terminal units belonging to other real estate agents admitted by said one real estate agent respectively, said system comprising:
a delivery information data base storing a plurality of pieces of information about real estate to be delivered to the terminal units;
a terminal unit data base storing a mail address, telephone number and another communication address for the terminal units;
a narrowing condition data base storing narrowing conditions set for every one of said other real estate agents; and
delivering means narrowing the information about the real estate stored by the delivery information data base on the narrowing conditions for every one of said other real estate agents for delivering, to the terminal unit stored by the terminal unit data base, the narrowed information about real estate.

2. The system of claim 1, wherein the narrowing condition is that the real estate the data of which is contained in the real estate information to be delivered is located in the same area as a business office of said other real estate agent to whom the real estate information is to be delivered is located.

3. The system of claim 1, wherein said one real estate agent is admitted to manage the real estate the data of which is contained in the real estate information stored in the delivery information data base even when said other real estate agent has sold the real estate or made a lease contract regarding the real estate.

4. The system of claim 1, wherein when the real estate the data of which is contained in the real estate information remains unsold for more than a predetermined period, an owner of the real estate imposes a predetermined amount of payment on said one real estate agent.

5. The system of claim 1, further comprising a master data base storing a plurality of pieces of real estate information which are prohibited from being delivered, wherein when the real estate the data of which is stored in the master data base remains unsold for more than a predetermined period, the real estate information is released from prohibition from delivery and taken into the delivery information data base.

6. The system of claim 2, further comprising a master data base storing a plurality of pieces of real estate information which are prohibited from being delivered, wherein when the real estate the data of which is stored in the master data base remains unsold for more than a predetermined period, the real estate information is released from prohibition from delivery and taken into the delivery information data base.

7. The system of claim 3, further comprising a master data base storing a plurality of pieces of real estate information which are prohibited from being delivered, wherein when the real estate the data of which is stored in the master data base remains unsold for more than a predetermined period, the real estate information is released from prohibition from delivery and taken into the delivery information data base.

8. The system of claim 4, further comprising a master data base storing a plurality of pieces of real estate information which are prohibited from being delivered, wherein when the real estate the data of which is stored in the master data base remains unsold for more than a predetermined period, the real estate information is released from prohibition from delivery and taken into the delivery information data base.

9. The system of claim 5, wherein the real estate information stored in the master data base is stored in the delivery information data base in response to operation by said one real estate agent.

10. The system of claim 1, wherein the terminal unit data base stores data of a date and time of delivery required by each of said other real estate agents and the delivering means is adapted to deliver the real estate information to the terminal unit when the date and time of delivery stored in the terminal unit data base has come.

11. The system of claim 2, wherein the terminal unit data base stores data of a date and time of delivery required by each of said other real estate agents and the delivering means is adapted to deliver the real estate information to the terminal unit when the date and time of delivery stored in the terminal unit data base has come.

12. The system of claim 3, wherein the terminal unit data base stores data of a date and time of delivery required by each of said other real estate agents and the delivering means is adapted to deliver the real estate information to the terminal unit when the date and time of delivery stored in the terminal unit data base has come.

13. The system of claim 4, wherein the terminal unit data base stores data of a date and time of delivery required by each of said other real estate agents and the delivering means is adapted to deliver the real estate information to the terminal unit when the date and time of delivery stored in the terminal unit data base has come.

14. The system of claim 5, wherein the terminal unit data base stores data of a date and time of delivery required by each of said other real estate agents and the delivering means is adapted to deliver the real estate information to the terminal unit when the date and time of delivery stored in the terminal unit data base has come.

15. The system of claim 9, wherein the terminal unit data base stores data of a date and time of delivery required by each of said other real estate agents and the delivering means is adapted to deliver the real estate information to the terminal unit when the date and time of delivery stored in the terminal unit data base has come.

16. The system of claim 10, wherein the terminal unit data base is capable of storing the mail address, telephone number and another communication address for every delivery date and time and for every terminal unit.

17. The system of claim 1, wherein said each terminal unit is any one of a personal computer, mobile phone, facsimile machine and personal digital assistance (PDA).

18. A method of information delivery wherein an information delivery system which is under control of one real estate agent delivers information about real estate handled by said one real estate agent via an Internet, telephone line or another network to terminal units belonging to other real estate agents admitted by said one real estate agent respectively, the method comprising:
storing a mail address, telephone number and another communication address on a terminal unit data base in response to requirement by each of said other real estate agents;
storing, on a narrowing condition data base, narrowing conditions set for every one of said other real estate agents in response to requirement by each of said other real estate agents or according to a location of a business office of each said other real estate agent;
storing, on a delivery information data base, information about real estate in response to operation by said one real estate agent or when the real estate remains unsold for more than a predetermined period; and
narrowing a plurality of pieces of real estate information stored on the delivery information data base for every one of said other real estate agents on the basis of the narrowing conditions and delivering the real estate information to the terminal unit the data of which is stored on the terminal unit data base.

19. An information delivery system for delivering information via a communication network to a terminal unit of a person desirous of the information, the information delivery system comprising:
a delivery information data base storing the information to be delivered to the terminal unit;
a terminal unit data base storing information about communication of the terminal unit;
a condition data base storing conditions set for every one of a plurality of the persons desirous of the information; and
delivering means causing the delivery information data base to store information narrowed under the conditions set for every one of said persons desirous of the information, the delivering means delivering the information stored on the information data base to the terminal unit the data of which is stored on the terminal unit data base.

20. The system of claim 19, further comprising a master table limiting delivery of information, wherein when a predetermined period has expired with respect to the information stored on the master table, the information is taken into the delivery information data base.

21. The system of claim 19, further comprising a master table limiting delivery of information, wherein information stored on the master table is optionally selected to be stored on the delivery information data base.

22. The system of claim 20, wherein information stored on the master table is optionally selected to be stored on the delivery information data base.

23. The system of claim 19, wherein the terminal unit data base stores data of a date and time of delivery required by each of said other real estate agents and the delivering means is adapted to deliver the information to the terminal unit when the date and time of delivery stored in the terminal unit data base has come.

24. The system of claim 20, wherein the terminal unit data base stores data of a date and time of delivery required by each of said other real estate agents and the delivering means is adapted to deliver the information to the terminal unit when the date and time of delivery stored in the terminal unit data base has come.

25. The system of claim 21, wherein the terminal unit data base stores data of a date and time of delivery required by each of said other real estate agents and the delivering means is adapted to deliver the information to the terminal unit when the date and time of delivery stored in the terminal unit data base has come.

26. The system of claim 23, wherein the terminal unit data base is capable of storing the information for every delivery date and time and for every terminal unit.

27. A method of delivering information via a communication network to a terminal unit of a person desirous of the information, the method comprising:
storing the information to be delivered to the terminal unit on a delivery information data base;
storing information about communication of the terminal unit on a terminal unit data base;
storing, on a condition data base, conditions set for every one of a plurality of the persons desirous of the information; and
storing, on the delivery data base, information narrowed under the conditions set for every one of said persons desirous of the information and delivering the information stored on the delivery data base to the terminal unit the data of which is stored on the terminal unit data base.
